(19) United States
(12) Patent Application Publication
(10) Pub. No.: US 2025/0385281 A1
(43) Pub. Date: Dec. 18, 2025

(54) METHOD AND APPARATUS FOR PRODUCING MEMBRANE ELECTRODE ASSEMBLY WITH SUB-GASKET

(71) Applicant: Robert Bosch GmbH, Stuttgart (DE)

(72) Inventor: Rikiya Yoshida, Saitama (JP)

(21) Appl. No.: 18/877,444

(22) PCT Filed: May 17, 2023
(86) PCT No.: PCT/IB2023/055082

§ 371 Date: Dec. 20, 2024

(30) Foreign Application Priority Data
Jun. 22, 2022 (JP) 2022-100180

(51) Int. Cl. H01M 8/0286; H01M 8/0273; H01M 8/1004

(52) U.S. Cl. CPC H01M 8/0286; H01M 8/0273; H01M 8/1004

(57) ABSTRACT

To enhance efficiency of a process for producing a membrane electrode assembly (3) with a sub-gasket (5).

A method for producing a membrane electrode assembly (3) with a sub-gasket (5) includes a step of stacking the sub-gasket (5) on the membrane electrode assembly (3) via an adhesive layer (6), and a step of heating and pressurizing, with a thermocompression member (101, 102), a stacked body of the membrane electrode assembly (3), the adhesive layer (6), and the sub-gasket (5) to join the membrane electrode assembly (3) and the sub-gasket (5), the production method further including a step of preheating, with a heating device (107, 108), the membrane electrode assembly (3) on which the adhesive layer (6) is stacked or the sub-gasket (5) on which the adhesive layer (6) is stacked, before heating with the thermocompression member (101, 102).

### BACKGROUND

The present invention relates to a method and an apparatus for producing a membrane electrode assembly with a sub-gasket.

Fuel cells generate power through chemical reaction between hydrogen gas and oxygen gas in the air. Fuel cells are usually cell stacks each including a plurality of cells, with one cell having a structure in which a membrane electrode assembly is sandwiched by a pair of separators. A sub-gasket is sometimes provided as a support or the like around the membrane electrode assembly.

For example, a membrane electrode assembly with a sub-gasket is produced by cutting the inside of a resin film for the sub-gasket, placing a membrane electrode assembly therein, and joining the membrane electrode assembly to the resin film (see JP2021-18832A, for example).

A membrane electrode assembly and a resin film can be joined to each other through thermocompression, with a hot-melt adhesive interposed therebetween. However, in the case of thermocompression, a heating time required for the adhesive to be sufficiently melted and a subsequent cooling time have been required, leading to delay in cycle time during production of a membrane electrode assembly.

### SUMMARY

An object of the present invention is to enhance efficiency of a process of producing a membrane electrode assembly with a sub-gasket.

An aspect of the present application is a method for producing a membrane electrode assembly (3) with a sub-gasket (5). The production method includes: a step of stacking the sub-gasket (5) on the membrane electrode assembly (3) via an adhesive layer (6); and a step of heating and pressurizing, with a thermocompression member (101, 102), a stacked body of the membrane electrode assembly (3), the adhesive layer (6), and the sub-gasket (5) to join the membrane electrode assembly (3) and the sub-gasket (5), the production method further including a step of preheating, with a heating device (107, 108), the membrane electrode assembly (3) on which the adhesive layer (6) is stacked or the sub-gasket (5) on which the adhesive layer (6) is stacked, before heating with the thermocompression member (101, 102).

Another aspect of the present application is an apparatus (100) for producing a membrane electrode assembly (3) with a sub-gasket (5). The production apparatus (100) includes: a conveying mechanism (103, 104) stacking the sub-gasket (5) on the membrane electrode assembly (3) via an adhesive layer (6); a thermocompression member (101, 102) heating and pressurizing a stacked body of the membrane electrode assembly (3), the adhesive layer (6), and the sub-gasket (5) to join the membrane electrode assembly (3) and the sub-gasket (5); and a heating device (107, 108) preheating the membrane electrode assembly (3) on which the adhesive layer (6) is stacked or the sub-gasket (5) on which the adhesive layer (6) is stacked, before heating with the thermocompression member (101, 102).

According to the present invention, efficiency of a process of producing a membrane electrode assembly with a sub-gasket can be enhanced.

### BRIEF DESCRIPTION OF THE DRAWINGS

FIG. 1 is a cross-sectional view illustrating a configuration example of a fuel cell.

FIG. 2 is a top view of a membrane electrode assembly with a sub-gasket.

FIG. 3 is a flowchart illustrating one example of a process of producing a membrane electrode assembly with a sub-gasket.

FIG. 4 is a diagram illustrating an outline of a joining process in a roll-to-roll method.

### DETAILED DESCRIPTION

Hereinafter, an embodiment of a method and an apparatus for producing a membrane electrode assembly with a sub-gasket according to the present invention will be described with reference to drawings. The configuration described below is an example (representative example) of the present invention, and the present invention is not limited to the configuration.

### Fuel Cell

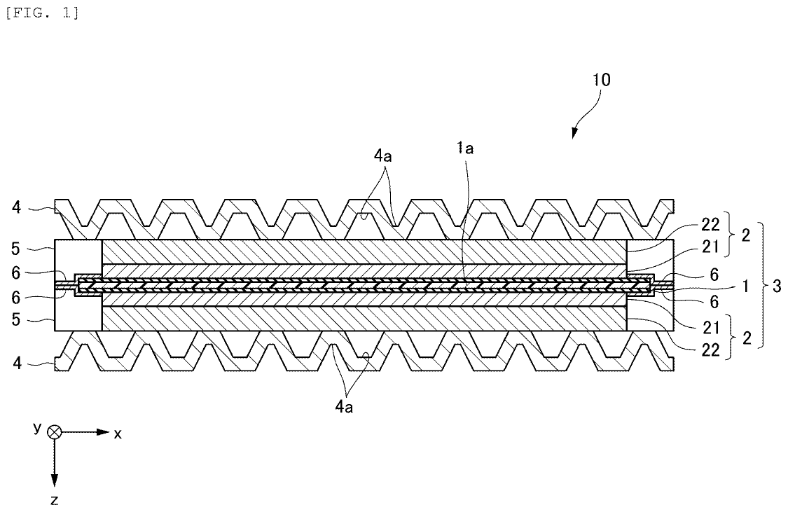

FIG. 1 illustrates an example of a configuration of a fuel cell 10.

As illustrated in FIG. 1, the fuel cell 10 includes an MEA 3, a pair of separators 4, and a sub-gasket 5. The MEA 3 includes an electrolyte membrane 1 and a pair of electrodes 2. The electrode 2 and the separator 4 are stacked, in the stated order, on each side of the electrolyte membrane 1. In the drawing, the z-direction represents the stacking direction. The x-direction and the y-direction are perpendicular to each other in the plane perpendicular to the z-direction.

The electrolyte membrane 1 is a membrane of an ion-conductive polymer electrolyte. Examples of the electrolyte membrane 1 include a perfluorosulfonic acid polymer such as Nafion (registered trademark) and Aquivion (registered trademark); an aromatic polymer such as a sulfonated poly (ether ether ketone) (SPEEK) and a sulfonated polyimide; and an aliphatic polymer such as a poly (vinyl sulfonic acid) and a poly (vinyl phosphoric acid).

The electrolyte membrane 1 may be a composite film in which a porous base material 1a is impregnated with a polymer electrolyte from the viewpoint of improving durability. The porous base material 1a is not particularly limited as long as it can carry a polymer electrolyte, and a porous film, a woven film, an unwoven film, a fibril film, and the like may be used. Although materials for the porous base material are also not particularly limited, the above-described polymer electrolytes may be used from the viewpoint of enhancing ion conductivity. Among these, polytetrafluoroethylene, polytetrafluoroethylene-chlorotrifluoroethylene copolymers, polychlorotrifluoroethylene, and the like, which are fluoropolymers, are excellent in strength and shape stability.

Among the pair of electrodes 2, one electrode 2 is an anode and is also referred to as a fuel electrode. The other electrode 2 is a cathode and is also referred to as an air electrode. Hydrogen gas is supplied to the anode, and air including oxygen gas is supplied to the cathode, as fuel gas.

In the anode, a reaction generating electrons (e⁻) and protons (H⁺) from hydrogen gas (H₂) occurs. Electrons move to the cathode through an external circuit (not shown). A current is generated in the external circuit through this movement of electrons. Protons move to the cathode through the electrolyte membrane 1.

In the cathode, oxygen ions (O₂⁻) are produced from oxygen gas (O₂) by electrons moving from the external circuit. Oxygen ions are coupled with protons (2H⁺) moving from the electrolyte membrane 1 to form water (H₂O).

The electrode 2 includes a catalyst layer 21. The electrode 2 of the present embodiment further includes a gas diffusion layer 22 in order to improve fuel gas diffusiveness.

The catalyst layer 21 promotes the reactions of hydrogen gas and oxygen gas by means of a catalyst. The catalyst layer 21 includes a catalyst, a carrier carrying the catalyst, and an ionomer covering the catalyst and the carrier.

Examples of the catalyst include metals such as platinum (Pt), ruthenium (Ru), iridium (Ir), rhodium (Rh), palladium (Pd), and tungsten (W), mixtures of these metals, and alloys of these metals. Among these, platinum, a mixture including platinum, an alloy including platinum, and the like are preferable from the viewpoint of catalytic activity, poisoning resistance against carbon monoxide, heat resistance, and the like.

Examples of the carrier include a conductive porous metallic compound having fine pores, such as acetylene black and Ketjen black.

The same ion-conductive polymer electrolytes as those used for the electrolyte membrane 1 may be used as the ionomer.

The gas diffusion layer 22 uniformly may diffuse fuel gas supplied to the fuel cell 10 to the entire surface of the catalyst layer 21.

The gas diffusion layer 22 may be formed by arranging a sheet for the gas diffusion layer as an outermost layer of the MEA 3. Examples of the sheet for the gas diffusion layer include a sheet material made from a metal such as a foamed metal and an expanded metal, besides porous fiber sheets having electrical conductivity, gas permeability, and gas diffusibility, such as a carbon fiber sheet.

### Separator

The separator 4 is also referred to as a bipolar plate. The separator 4 of the present embodiment is a plate having a surface on which a recessed part 4a is provided. When the separator 4 is disposed on the both sides of the MEA 3, a flow passage for fuel gas is formed by an inner wall of the recessed part 4a of the separator 4 and a surface of the MEA 3.

A conductive material is used as a material for the separator 4. Examples of the conductive material include metals such as stainless steel or carbon composites.

### Sub-Gasket

The sub-gasket 5 is a film or a plate provided in an end part of the MEA 3. The sub-gasket like this functions as a member for protecting a support or the end part of the MEA 3. The sub-gasket 5 abuts on the separator 4 and may seal the inside of the fuel cell 10.

A resin with low electrical conductivity may be used as a material for the sub-gasket 5. Examples of such a resin material include polyethylene terephthalate (PET), polyethylene naphthalate (PN), polyphenylene sulfide (PPS), glass-containing polypropylene (PP-G), polystyrene (PS), silicone resin, and fluororesin.

### Adhesive Layer

The fuel cell 10 includes an adhesive layer 6 between the sub-gasket 5 and the MEA 3. The sub-gasket 5 is joined to the MEA 3 via the adhesive layer 6. The adhesive layer 6 contains a hot-melt adhesive. Thermoplastic resins including olefin resins such as polypropylene and polyethylene, as well as thermoplastic elastomers such as ethylene-vinyl acetate (EVA) may be used as the hot-melt adhesive, for example.

From the viewpoint of heat resistance, a melting point or a softening point of the adhesive layer 6 is a temperature higher than an operation temperature (for example, 70° C. to 85° C.) of the fuel cell 10, is 90° C. or higher, for example, and is preferably 100° C. or higher and more preferably 110° C. or higher. From the viewpoint of shortening the time for a joining process, the melting point or the softening point of the adhesive layer 6 is preferably 150° C. or lower and more preferably 130° C. or lower.

In the MEA 3 of the present embodiment, the electrolyte membrane 1 protrudes in the x-direction and in the y-direction more than the electrode 2. Therefore, the protruded part is joined to the sub-gasket 5 via the adhesive layer 6; however, the joining position is not limited thereto, and a position suitable for a shape of the MEA 3 may be employed. For example, when the positions of end parts of the electrolyte membrane 1 and the electrode 2 in the x-direction and the y-direction are the same, a sub-gasket is joined onto the end part of the electrode 2.

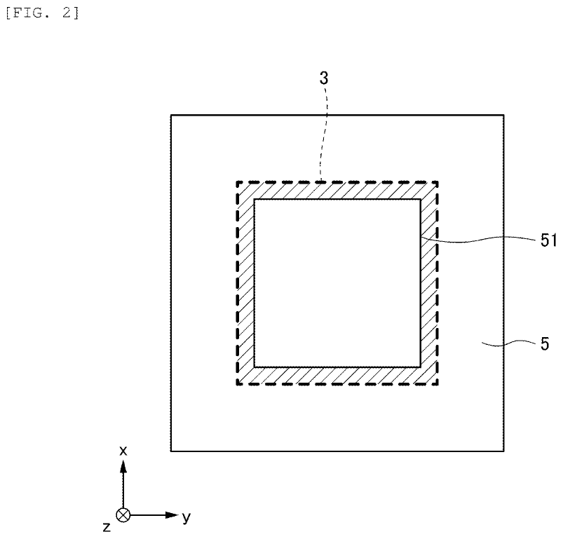

FIG. 2 is a top view of the MEA 3 with the sub-gasket 5.

The sub-gasket 5 has a frame-like shape in which the central part thereof is cut. An area of the MEA 3 is slightly larger than a cut region 51. The MEA 3 is disposed in the cut region 51 of the sub-gasket 5, and the MEA 3 and the sub-gasket 5 are joined, with an end part of the sub-gasket 5 on the inner peripheral side overlapping with an end part of the MEA 3.

The shaded region in FIG. 2 is a region in which the MEA 3 and the sub-gasket 5 are joined. The adhesive layer 6 may be provided in the entire area of a surface of the sub-gasket 5 or may be provided only in the shaded region to be joined to the MEA 3.

### Production Method

The above-described fuel cell 10 may be produced by arranging the separator 4 on both sides of the MEA 3 with the sub-gasket 5.

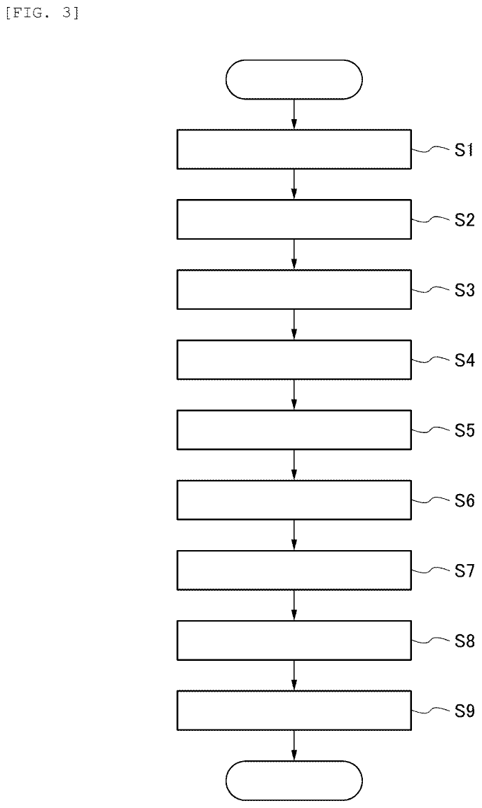

FIG. 3 is a flowchart illustrating one example of a process of producing the MEA 3 with the sub-gasket 5.

In step S1, the adhesive layer 6 is stacked on one surface of the MEA 3. For example, the adhesive layer 6 is provided by applying an adhesive onto a surface of an end part (for example, the shaded region in FIG. 2) of the MEA 3. The adhesive layer 6 may be provided on the entire surface of the sub-gasket 5 or on an end part (for example, the shaded region in FIG. 2) on the inner peripheral side of the sub-gasket 5, or may be provided on both of a surface of the MEA 3 and a surface of the sub-gasket 5. The method for forming the adhesive layer 6 is not limited to a method by application.

In step S2, the MEA 3 or the sub-gasket 5 provided with the adhesive layer 6 is preheated by a heating device. From the viewpoint of melting the adhesive layer 6, among the MEA 3 and the sub-gasket 5, one provided with the adhesive layer 6 may be preheated. From the viewpoint of reducing displacement of the joining position due to difference in heat shrinkage between the MEA 3 and the sub-gasket 5, it is preferable that both of the MEA 3 and the sub-gasket 5 are preheated.

After the preheating, in step S3, the sub-gasket 5 is stacked on one surface of the MEA 3 via the adhesive layer 6. That is, an end part on the inner peripheral side of the sub-gasket 5 is overlapped with an end part of the MEA 3. Stacking is conducted by a conveying mechanism. For example, the MEA 3 with the adhesive layer 6 is conveyed, and the sub-gasket 5 is further conveyed and stacked onto the adhesive layer 6.

In step S4, a stacked body of the MEA 3, the adhesive layer 6, and the sub-gasket 5 is heated and pressurized by a thermocompression member. The MEA 3 and the sub-gasket 5 are thereby joined via the adhesive layer 6 (hereinafter, joining by heating and pressurizing is sometimes referred to as thermocompression). The entire region of the stacked body may be subjected to thermocompression, or only a partial region in which the MEA 3 and the sub-gasket 5 are overlapped may be subjected to thermocompression.

A heating temperature in the joining process is higher than the melting point or the softening point of the adhesive layer 6. The thermocompression member is not particularly limited as long as it can perform heating and pressurization, and examples thereof include a roller member and a plate member such as an upper plate and a lower plate sandwiching the stacked body.

The adhesive layer 6 can be sufficiently melted by increasing the heating temperature of the thermocompression member or by adjusting a contact time with the thermocompression member to increase the heating time; however, production cycle time is delayed thereby. When the heating temperature is increased, subsequent cooling requires more time, and when the heating time is increased, the joining process becomes a bottleneck. The heating time can be increased without decreasing speed by increasing the number of thermocompression members; however, costs for production facilities increase.

On the other hand, by carrying out the preheating process as described above, the adhesive layer 6 is easily melted sufficiently with less thermal energy in the subsequent joining process. Compared with the case where no preheating is performed, the heating temperature during thermocompression can be decreased to decrease the subsequent cooling time, or the heating time itself can be decreased. Therefore, the above-described delay in cycle time can be overcome, and efficiency of the production process can be enhanced. The number of thermocompression members is not required to be increased for efficiency, and increase in costs can be avoided.

Next, in step S5, the adhesive layer 6 is provided on the other surface of the MEA 3. The adhesive layer 6 may be formed in the same manner as step S1.

In step S6, the MEA 3 or the sub-gasket 5 provided with the adhesive layer 6 is preheated by the heating device. This preheating process can be carried out in the same manner as step S2.

In step S7, the sub-gasket 5 is stacked on the other surface of the MEA 3 via the adhesive layer 6. That is, an end part of the MEA 3 is overlapped with an end part on the inner peripheral side of the sub-gasket 5, also on the other surface.

After the preheating, in step S8, the stacked body of the sub-gasket 5, the adhesive layer 6, the MEA 3, the adhesive layer 6, and the sub-gasket 5 is heated and pressurized by the thermocompression member. The sub-gasket 5 is joined to the both sides of the MEA 3 thereby. Since the adhesive layer 6 may be sufficiently melted with less thermal energy by performing preheating as with the joining process in step S4, efficiency of the production process is enhanced as described above.

The joined stacked body is cut in step S9 as necessary. For example, as a sheet of the stacked body is obtained in the case of a roll-to-roll method, the MEA 3 with the sub-gasket 5 for one cell is produced by cutting at between the MEA 3 and the MEA 3.

FIG. 4 illustrates an outline of the joining process in a roll-to-roll method.

A production apparatus 100 illustrated in FIG. 4 includes a pair of first rollers 101, and conveying mechanisms 103, 104, and 106. The conveying mechanisms 103, 104, and 106 may be composed of a plurality of rollers, a belt wound around a roller, or the like. The production apparatus 100 as described above may be incorporated as part of a production line for the MEA 3 with the sub-gasket 5, and a production line for assembling a fuel cell 10 using the MEA 3.

The conveying mechanism 103 conveys the sub-gasket 5 having a long sheet shape to the first rollers 101. The sub-gasket 5 includes the adhesive layer 6 on a surface facing the MEA 3. A cover film 7 is stacked on the adhesive layer 6. The cover film 7 is wound around a winder 105 on an upstream side in the conveying direction from the first rollers 101.

The conveying mechanism 104 conveys the MEA 3 to the first rollers 101. The sub-gasket 5 is joined to one surface of the MEA 3 in advance via the adhesive layer 6. The sub-gasket 5 conveyed by the conveying mechanism 104 is stacked on the other surface of the MEA 3 conveyed by the conveying mechanism 103 in between the pair of first rollers 101.

The first rollers 101 are one example of the thermocompression member. A roller having a built-in heater, a roller circulating a heat medium, and the like may be used as the first rollers 101, for example. The MEA 3 and the sub-gasket 5 stacked in between the pair of first rollers 101 are heated and pressurized by the first rollers 101.

Consequently, the sub-gasket 5 is joined to the other surface of the MEA 3 via the melted adhesive layer 6. In this way, a sheet in which the sub-gasket 5 is joined to the end part on each side of the MEA 3 is conveyed by the conveying mechanism 106. After cooling the sheet, the sheet is cut at between adjacent MEAs 3 to obtain the MEA 3 with the sub-gasket 5 for one cell.

The production apparatus 100 of the present embodiment includes heating devices 107 and 108. The heating devices 107 and 108 are disposed on the upstream side in the conveying direction from the first rollers 101 and preheat the MEA 3 or the sub-gasket 5 before thermocompression with the first rollers 101.

Although preheating may be performed in a non-contact method or a contact method, a non-contact method is preferable because a heatable area is large. Examples of the non-contact devices for the heating devices 107 and 108 include heat radiation-type heating devices such as an infrared heater, a far-infrared heater, and a halogen lamp; and convection-type heating devices such as a hot air blower. Examples of the contact devices for the heating devices 107 and 108 include heat-transfer heating devices such as a heated roller and a heated belt.

The heating device 107 preheats the sub-gasket 5 provided with the adhesive layer 6. In the present embodiment, the heating device 107 is disposed on the surface side opposed to the adhesive layer 6 of the sub-gasket 5 in the vicinity of the conveying mechanism 103; however, the heating device 107 may be disposed on the surface side of the adhesive layer 6 in order to impart more thermal energy to the adhesive layer 6.

The heating device 108 preheats the surface of the MEA 3 on which the adhesive layer 6 is provided and the surface of the sub-gasket 5 on which the adhesive layer 6 is provided. The heating device 108 is disposed at the position at which the adhesive layer 6 preliminarily provided to the MEA 3 and the adhesive layer 6 on the sub-gasket 5 face each other. When the adhesive layer 6 is provided to both of the MEA 3 and the sub-gasket 5 as in this case, both of the adhesive layers 6 may be both sufficiently melted by preheating both of the adhesive layers 6 even heating time during the joining process is short. The displacement between the MEA 3 and the sub-gasket 5 at the time of stacking can be reduced by preheating both of the adhesive layers 6.

It is preferable that the preheating time by the heating devices 107 and 108 is increased as the speed at which the MEA 3 or the sub-gasket 5 is conveyed to the first rollers 101 increases. When the preheating time is long, the adhesive may be sufficiently melted even when the heating time during the joining process is short, and a bottle neck can be overcome.

A preheating temperature with the heating devices 107 and 108 is preferably adjusted to fall within a range of −20° C. or more and up to 0° C. with respect to the melting point or the softening point of the adhesive from the viewpoint of sufficiently melting the adhesive. The preheating temperature with the heating devices 107 and 108 may be adjusted such that the closer the position is to the first rollers 101, the higher the preheating temperature is.

By virtue of the above-described preheating, the adhesive layer 6 may be sufficiently melted only by the first rollers 101, and an additional thermocompression member is not required; therefore, production costs are suppressed. However, an additional thermocompression member may be provided for adjusting the pressure, heating temperature, or heating time during the joining process. For example, the production apparatus 100 may include one or more pairs of second rollers 102, which are thermocompression members, in addition to the first rollers 101.

The above-described production apparatus 100 may be used in each process (steps S2 to S4) of joining the sub-gasket 5 to one surface of the MEA 3. In this case, the MEA 3 with no sub-gasket 5 joined thereto is attached to a back sheet, the same is conveyed by the conveying mechanism 104, and the sub-gasket 5 conveyed by the conveying mechanism 103 is joined to one surface thereof.

While the production process in which the sub-gasket 5 is sequentially joined to each surface has been described, the sub-gasket 5, the adhesive layer 6, the MEA 3, the adhesive layer 6, and the sub-gasket 5 may be stacked at once in the stated order, and the sub-gasket 5 may be joined to both surfaces of the MEA 3 at once.

When the MEA 3 or the sub-gasket 5 thermally shrinks through the joining process or the preheating process, the change in dimension before and after thermal shrinkage may be calculated in advance. The position at which the MEA 3 and the sub-gasket 5 are joined may be adjusted by adjusting the conveying timing of the MEA 3 or the sub-gasket 5 at the first rollers 101 according to the calculated change in dimension.

As described above, the method for producing the MEA 3 with the sub-gasket 5 of the present embodiment includes steps (a) and (b) blow:
(a) stacking the sub-gasket 5 on the MEA 3 via the adhesive layer 6; and
(b) heating and pressurizing the stacked body of the MEA 3, the adhesive layer 6, and the sub-gasket 5 with the thermocompression member to join the MEA 3 and the sub-gasket 5.

The above production method further includes step (c) below:
(c) preheating the MEA 3 on which the adhesive layer 6 is provided or the sub-gasket 5 on which the adhesive layer 6 is provided before heating with the thermocompression member.

By virtue of preheating, the adhesive layer 6 may be sufficiently melted with less thermal energy during joining. The heating time in the joining process is not required to be increased, and the speed of the entire production line is thus not required to be decreased; therefore, efficiency of the production process can be enhanced.

Since thermal energy required during joining is small, the heating temperature during thermocompression can be decreased, or the number of the second rollers 102 can be decreased when the second rollers 102 are provided. Therefore, increase in production costs can be suppressed.

Hereinabove, a preferable embodiment of the present invention has been described; however, the following modification is possible, and the modification may be combined with the above-described embodiment.

### Modification

The present invention is applicable to a batch-type production process.

In the batch-type process, a plate-shaped thermocompression member can be used. A die-shaped thermocompression member that thermally compresses only a region to be joined may be used.

In the batch-type process, an arm and the like can be used as a mechanism for conveying the MEA 3 and the sub-gasket 5 in addition to a roller and a belt. The MEA 3 and the sub-gasket 5 provided with the adhesive layer 6 is preheated with a heating device until being conveyed to the position in between the thermocompression member. Efficiency of the production process can be thereby enhanced as with the case of a roll-to-roll method.

### REFERENCE SIGNS LIST

10: Fuel cell
1: Electrolyte membrane
2: Electrode
21: Catalyst layer
22: Diffusion layer
3: Membrane electrode assembly (MEA)
4: Separator
5: Sub-gasket
6: Adhesive layer
100: Production apparatus
101: First roller
102: Second roller
103,104: Conveying mechanism
107,108: Heating device

1. A method for producing a membrane electrode assembly (3) with a sub-gasket (5), the method comprising:
stacking a sub-gasket (5) on a membrane electrode assembly (3) via an adhesive layer (6);
heating and pressurizing, with a thermocompression member (101, 102), a stacked body of the membrane electrode assembly (3), the adhesive layer (6), and the sub-gasket (5) to join the membrane electrode assembly (3) and the sub-gasket (5); and,
preheating, with a heating device (107, 108), the membrane electrode assembly (3) on which the adhesive layer (6) is stacked or the sub-gasket (5) on which the adhesive layer (6) is stacked, before heating with the thermocompression member (101, 102).

2. The production method according to claim 1, wherein
the preheating with the heating device (107, 108) is performed in a non-contact method.

3. The production method according to claim 1, wherein
the heating device (107, 108) preheats one provided with the adhesive layer (6) among the membrane electrode assembly (3) and the sub-gasket (5).

4. The production method according to claim 1, wherein
the heating device (107, 108) preheats a surface provided with the adhesive layer (6) of the membrane electrode assembly (3) or the sub-gasket (5).

5. The production method according to claim 1, wherein
when the sub-gasket (5) is joined to a first surface of the membrane electrode assembly (3) in advance and the sub-gasket (5) provided with the adhesive layer (6) is stacked on a second surface of the membrane electrode assembly (3), the heating device (107, 108) preheats both of the membrane electrode assembly (3) and the sub-gasket (5) provided with the adhesive layer (6).

6. The production method according to claim 1, wherein
a time for the preheating is increased as speed at which the membrane electrode assembly (3) and the sub-gasket (5) are conveyed to the thermocompression member (101, 102) increases.

7. An apparatus (100) for producing a membrane electrode assembly (3) with a sub-gasket (5), comprising:
a conveying mechanism (103, 104) stacking the sub-gasket (5) on the membrane electrode assembly (3) via an adhesive layer (6);
a thermocompression member (101, 102) heating and pressurizing a stacked body of the membrane electrode assembly (3), the adhesive layer (6), and the sub-gasket (5) to join the membrane electrode assembly (3) and the sub-gasket (5); and
a heating device (107, 108) preheating the membrane electrode assembly (3) on which the adhesive layer (6) is stacked or the sub-gasket (5) on which the adhesive layer (6) is stacked, before heating with the thermocompression member (101, 102).
